(19) United States
(12) Patent Application Publication
(10) Pub. No.: US 2007/0118852 A1
(43) Pub. Date: May 24, 2007

(54) Virtual television channels for audio-video system

(75) Inventor: Richard C. Calderwood, Portland, OR (US)

Correspondence Address: Richard Calderwood;Stexar Corp., 20400 NW Amberwood Dr. #100, Beaverton, OR, 97006-7099, US

(73) Assignee: Stexar Corp.

(21) Appl. No.: 11/285,455

(22) Filed: Nov. 22, 2005

(51) Int. Cl. G06F 13/00; H04N 7/173; H04N 5/445; G06F 3/00

(52) U.S. Cl. 725/38; 725/61; 725/87

(57) ABSTRACT

An A/V system in which the user can set up a “virtual television channel” which includes the video from one channel and the audio from another channel. The virtual channel is included in the on-screen programming guide, and is user-selectable for viewing or recording just like the actual channels. The user may use a virtual channel to get the 5.1 surround audio from an HD broadcast with the video from an SD simulcast, or to include one football game's audio content with two football games' video content for an improved pip capability, or to get classical music with a stock ticker video, and so forth.

### BACKGROUND OF THE INVENTION

1. Technical Field of the Invention

This invention relates generally to audio-video (A/V) systems such as television systems, and more specifically to A/V systems enabling a user to set up a virtual television channel which, when viewed, presents video from one source and audio from another source.

2. Background Art

A/V systems have evolved to include a multitude of audio and video sources available to the user at a single system. For example, the user may use his home A/V receiver to listen to audio from a CD changer, an audio capable DVD player, a cassette tape deck, an iPod MP3 player, FM radio, AM radio, satellite radio, and so forth. The user may switch his home A/V system to watch video from terrestrial television broadcast, cable television, satellite television, DVD, VHS tape, a PC media server, and so forth. Video typically also has accompanying audio.

In some A/V systems, the switching between various audio or video sources is done by selecting between mutually exclusive inputs connected to a receiver unit. In a typical system of this type, the user may have connected the video and audio outputs of a DVD player, a VHS player, a digital video recorder (DVR), a cable set-top box, a satellite receiver, etc. to respective video and audio input connectors on the back of the receiver, and the audio outputs of a CD player, iPod, satellite radio receiver, etc. to respective additional audio input connectors on the back of the receiver. Some A/V components may also be connected to input connectors on the front of the receiver, typically those from Nintendo, XBox, and other video gaming systems or from video cameras. In other A/V systems, the television itself may provide this switching function.

In existing systems, when the user selects a particular video source, the receiver (or other switching unit) simultaneously selects that video source's audio, such that the user is always presented with video (if any) and audio from a single source.

Sometimes, however, the user may wish to watch one source's video content and simultaneously listen to another source's audio content. For example, in the 1970s, this inventor's parents would tune their black-and-white television to watch Phoenix Suns basketball games, but they would turn the television audio volume off and listen to the simultaneous AM radio broadcast of the same basketball game. To accomplish this, they would manually turn the television set's volume knob all the way down, and set a separate radio on top of the television set. If, e.g. during a commercial or halftime, they wanted to briefly watch a different television channel, they had to get up from the couch and manually turn off the radio and turn up the television's audio volume knob. Then, to switch back to the basketball game, they had to reverse this process.

A similar issue exists even within television broadcasts themselves. When the user changes television channels, both the audio and video are switched to those of the newly selected channel.

Many televisions and set-top boxes etc. have included “picture-in-picture” (pip) capability. When the user selects pip mode, two separate receivers are employed, with the video from one being displayed in a primary “window” on the television display panel, and the video from the other being displayed in a secondary, typically smaller, window on the television display panel. The A/V system plays the audio of whichever program is displayed in the primary pip window.

What is desirable is an improved A/V system which enables the user to manually select video from one source and audio from another source. What is further desirable is an improved A/V system in which this combination can be saved for later reuse.

### BRIEF DESCRIPTION OF THE DRAWINGS

FIG. 1 shows an A/V system according to one embodiment of this invention, in which a television set includes an I/O control system enabling the user to select video from one source and audio from another source.

FIG. 2 illustrates an A/V system according to another embodiment of this invention.

FIG. 3 is a flowchart illustrating one method whereby the user can set up a “virtual channel” having video from one source and audio from another source.

FIG. 4 illustrates an A/V system having an enhanced on-screen television channel guide including a virtual channel.

FIG. 5 is a flowchart illustrating one method of operation of the A/V system.

FIG. 6 illustrates another A/V system according to another embodiment of this invention.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

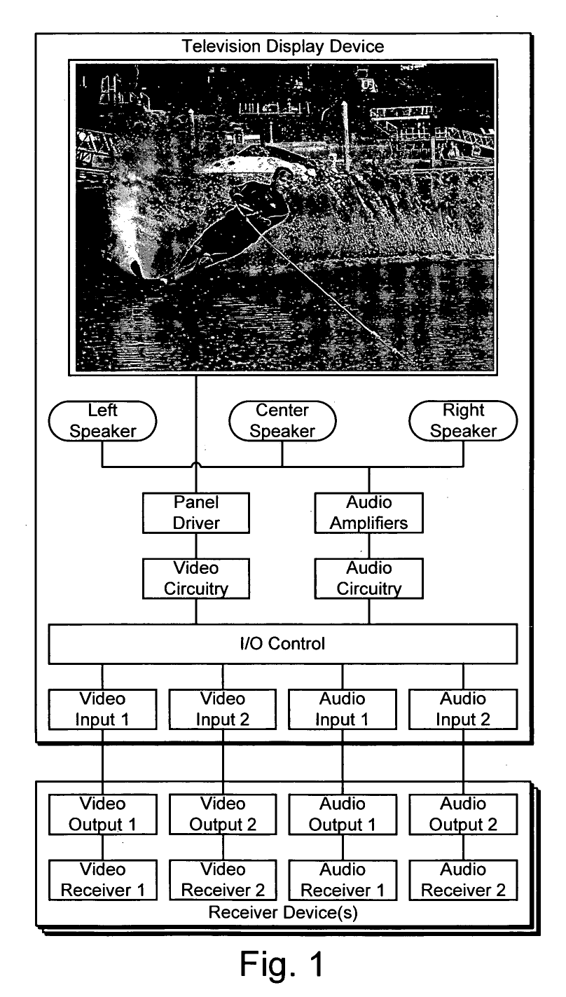

FIG. 1 illustrates an A/V system according to one embodiment of this invention. The A/V system includes a television display device which includes a display panel, illustrated as displaying a scene from a waterskiing program. The display panel is driven by panel driver circuitry, which in turn receives its display data from video circuitry. The panel driver circuitry includes electronics adapted for driving the pixels of the display panel, while the video circuitry includes electronics adapted for performing higher-level functions such as MPEG decoding, video post-processing, and the like. The television display device includes audio transducers, such as left, center, and right channel loudspeakers. The loudspeakers are driven by audio amplifiers, which receive audio signals from audio circuitry.

The television display device includes a plurality of video input connectors (illustrated as video input 1 and video input 2) and a plurality of audio input connectors (illustrated as audio input 1 and audio input 2).

The television display device receives video and audio signals at these input connectors from one or more external receiver devices. The receiver devices include a plurality of video receivers and a plurality of audio receivers. Each individual receiver device may contain any number of video receivers and/or any number of audio receivers. Examples of receiver devices include: cable set-top boxes, satellite television receivers, terrestrial television tuners, FM radio receivers, AM radio receivers, internet-connected computers, and so forth. More localized devices might even be said to be receiver devices of sorts; for example, a DVD player may be thought of as a receiver which receives video and audio content from a removable disc.

The television display device includes an I/O control mechanism which controls the receipt or switching of the video and audio signals received at the various input connectors.

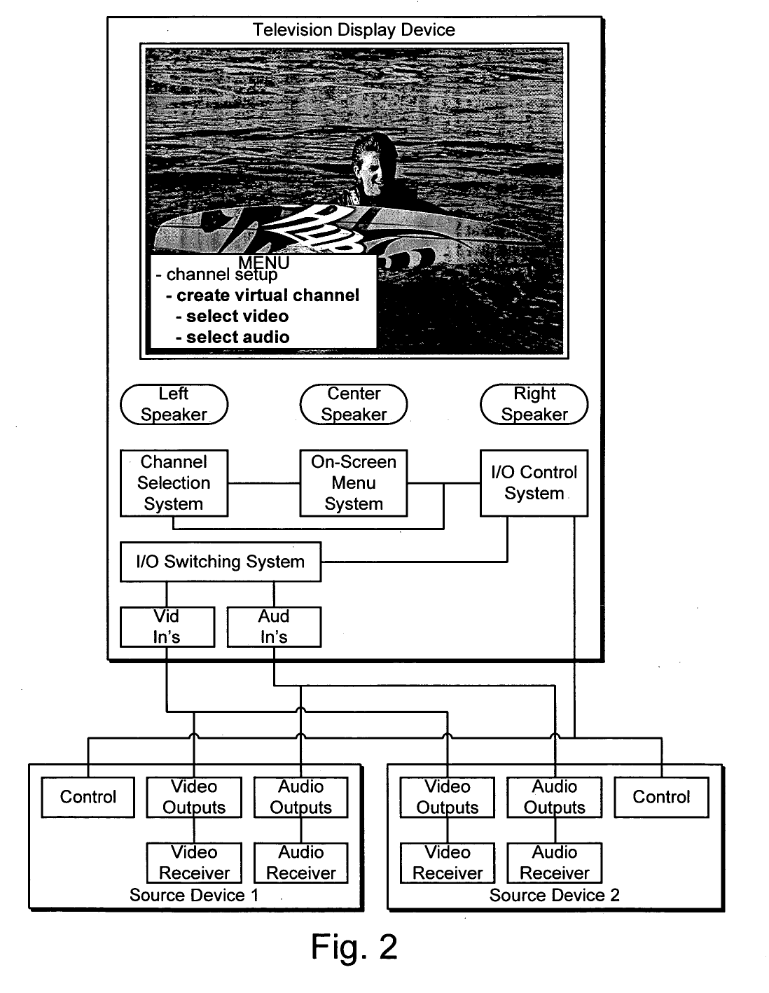

FIG. 2 illustrates an A/V system which is partitioned slightly differently and which illustrates other principles of this invention. The A/V system includes a television display device coupled to a plurality of separate source devices. The source devices may be local or remote, and may include any sort of video and/or audio content provision devices, such as: terrestrial television tuners, satellite television receivers, cable television receivers, DVD players, SACD audio players, FM/AM radio receivers, laser disc players, iPods, computer media servers, and so forth.

The television display device includes a display panel, illustrated as displaying a scene from a wakeboarding program, and an on-screen menu system which provides on-screen menus and the underlying functionality which the user can invoke via them. The on-screen menu system may operate upon electronic programming guide data received from one of the external sources.

The television display device further includes a channel selection system via which the user can select a program for viewing, from a multitude of television channels available via the source devices. Typically, the user may perform channel selection via the on-screen menu system.

The television display device further includes an I/O control system which controls the operation of an I/O switching system. The I/O switching system selects from video and audio signals arriving at a plurality of video inputs and a plurality of audio inputs.

The I/O control system, on-screen menu system, and channel selection system interact, as will be explained below. The I/O control system sends control signals to control inputs of the source devices, causing them to e.g. select a particular television channel, or other operational parameters.

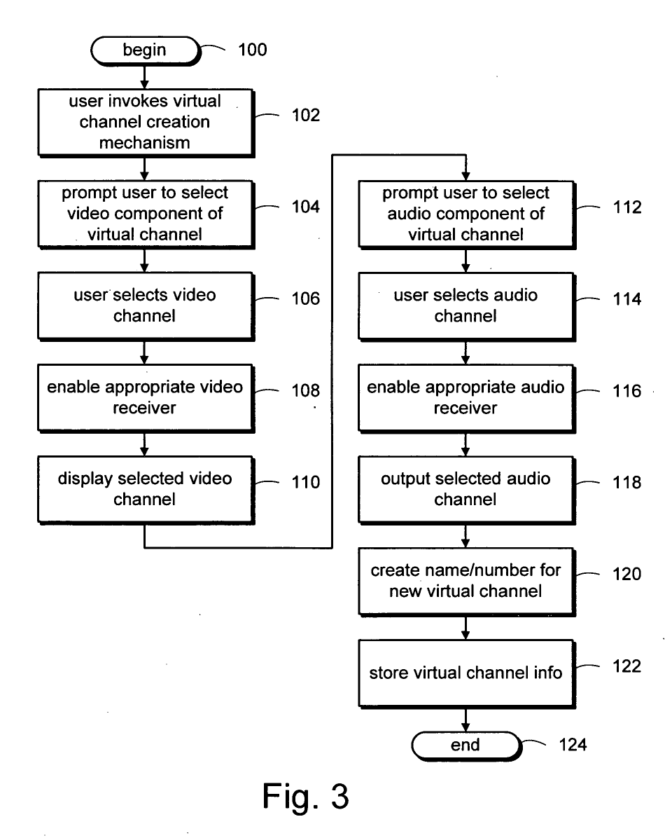

FIG. 3 is a flowchart illustrating one method of operation of the television display device (or other A/V component in the system) whereby the user can create a “virtual channel”. The reader may wish to also refer to FIGS. 1 and 2. The method begins (100) with the user invoking (102) the virtual channel creation mechanism. In one embodiment, he does this via the on-screen menu system, shown in FIG. 2 as a menu overlay on top of the video image. The on-screen menu system prompts (104) the user to select the video component of the virtual channel. The user responds by selecting (106) a video channel. The user may select any of the available video channels or devices, from any of the available video sources. In response to the user's selection, the I/O control system and channel selection system enable (108) the appropriate video receiver, and the I/O switching system switches the selected video channel through to the video circuitry and panel driver, and the selected video is displayed (110) on the display panel.

The on-screen menu system prompts (112) the user to select the audio component of the virtual channel. In response, the user selects (114) the audio content which he wishes to pair with the selected video content. This pair is thus made into a “virtual channel”. The I/O control system and channel selection system enable (116) the appropriate audio receiver, the I/O switching system switches the selected audio channel through to the audio circuitry and audio amplifiers, and the selected audio is output (118) or “played” via the loudspeakers.

The I/O control system, on-screen menu system, and/or channel selection system may then create (120) a name and/or number for the new virtual channel. They may do this automatically, or they may prompt the user to provide the name and/or number. This virtual channel information (video channel, audio channel, name, and number) are stored (122) in the on-screen menu system for subsequent reuse.

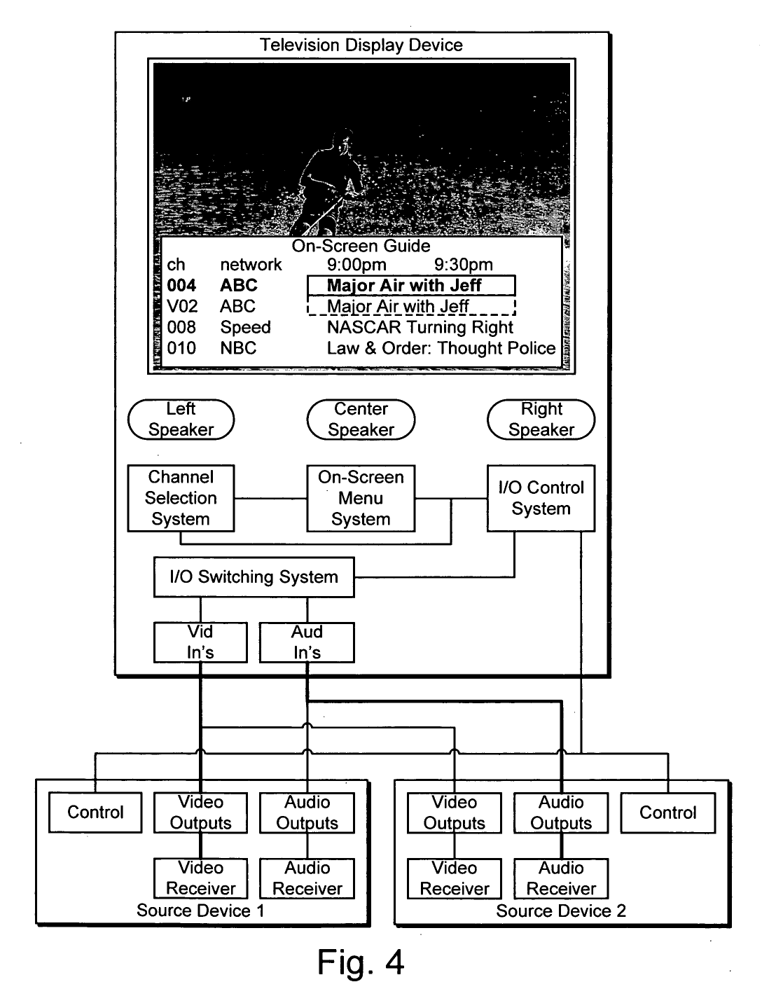

FIG. 4 illustrates the A/V system in use by the user, particularly demonstrating one method whereby the user can select a virtual channel which he has previously defined. The user has pulled up the on-screen programming guide, which the on-screen menu system presents as an overlay on top of the video. In one embodiment, the virtual channel is inserted into the EPG data at a suitable location. In the embodiment shown, the user has “arrowed” down to select channel 004 (as indicated by the bold highlighting of that row's text, and the solid box around that program's title), and the on-screen menu system has determined that a virtual channel has been defined whose video component is to be taken from the video of the selected channel, so the on-screen menu system has inserted the virtual channel V02 directly beneath the selected channel. The virtual channel is highlighted, such as by the dashed box around the program's title. In one embodiment, the user can then “arrow down” one row to select the virtual channel, and then select it by pressing e.g. the enter key on his remote control unit (not shown).

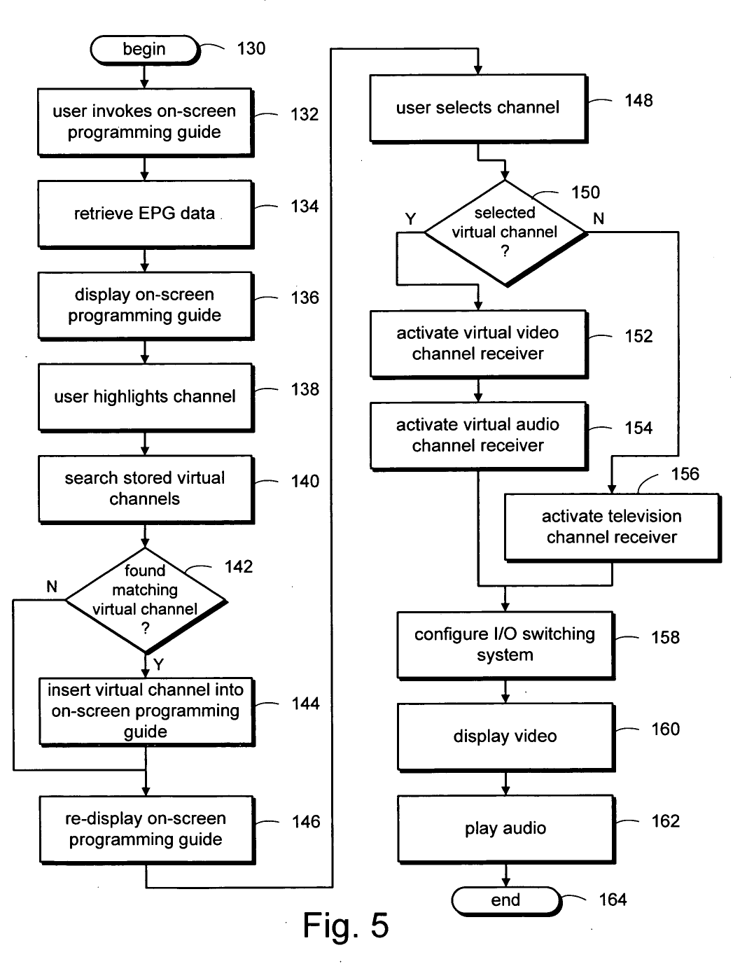

FIG. 5 is a flowchart illustrating one method of performing the virtual channel selection. The method begins (130) when the user invokes (132) the on-screen programming guide. The on-screen menu system retrieves (134) the EPG data, selects the appropriate data from it, and displays (136) the on-screen programming guide. Typically, the on-screen menu system will select a subset of the EPG data, beginning at the currently-viewed channel, and including as many next-higher-numbered channels as will fit in the menu window. The user “arrows up and down”, highlighting (138) one channel at a time. Each time the user highlights a channel, the on-screen menu system searches (140) the stored virtual channel data. If (142) the on-screen menu system finds a virtual channel which matches the currently highlighted channel, that virtual channel's information is inserted (144) into the on-screen programming guide, and the on-screen programming guide is redisplayed (146).

The flowchart is somewhat simplified, for clarity and simplicity. Eventually, the user selects (148) a channel (e.g. by pressing the “enter” key, as opposed to merely highlighting a channel by “arrowing up and down”). If (150) the user has selected an “actual” channel rather than a virtual channel, the channel selection system and I/O control system activate (156) the appropriate television channel receiver. If (150) the user has selected a virtual channel, the channel selection system and I/O control system activate (152) the video receiver from which the video content of the virtual channel is to be taken, and activate (154) the audio receiver from which the audio content of the virtual channel is to be taken. The I/O control system configures (158) the I/O switching system to connect the selected channel's video and audio in to the television display device's video and audio circuitry. The video circuitry and panel driver display (160) the selected virtual or actual channel's video content, and the audio circuitry and amplifiers play (162) the selected virtual or actual channel's audio content.

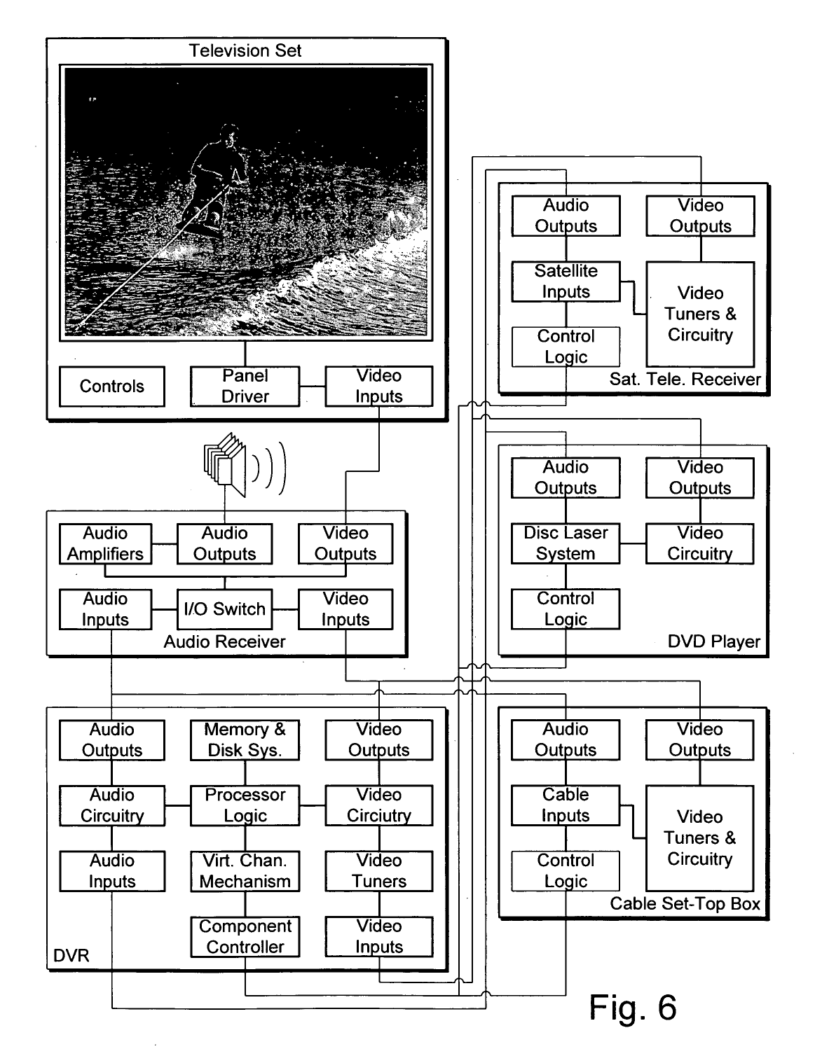

FIG. 6 illustrates an A/V system partitioned somewhat differently. The A/V system includes an audio receiver to which are coupled a television set, a DVR, a satellite television receiver, a DVD player, and a cable set-top box. In this particular system, the invention is embodied within the DVR.

The DVR includes one or more video inputs connected to one or more video tuners, which are connected to video circuitry. The video circuitry is coupled to at least one video output. The DVR further includes one or more audio inputs connected to audio circuitry, which is connected to one or more audio outputs. Processor logic, whether fixed function such as an ASIC or programmable such as a microprocessor or digital signal processor, provides intelligence of the DVR. A memory and disk system provides storage for recorded television programs, control applications, EPG data, and so forth. A virtual channel mechanism provides the virtual channel functionalities of this invention. A component controller provides the ability to control operation of the satellite television receiver, DVD player, and cable set-top box.

The audio receiver includes a plurality of audio inputs, which may be coupled to the audio outputs of the DVR, satellite television receiver, DVD player, and cable set-top box. The audio receiver includes a plurality of video inputs, which may be coupled to the video outputs of the DVR, satellite television receiver, DVD player, and cable set-top box. The audio receiver includes a conventional, user-operable I/O switch which controls which of the audio inputs is connected to a set of audio amplifiers which are in turn connected to a plurality of audio outputs, and which of the video inputs is connected to a set of video outputs. The audio receiver may be a conventional A/V system receiver, in that it may perform “lock-step” switching of audio and video connections, such that, for example, if the DVD player is selected as the source, both the DVD video input and DVD audio input are switched through to the outputs of the audio receiver.

The user can select any of the components as the input source for the audio receiver. But, to watch a virtual channel, the user must select the DVR as the input source for the audio receiver. In the configuration shown, the satellite television receiver, DVD player, and cable set-top box have their outputs connected to inputs of the DVR. The user can use the DVR to watch or record actual channels from these devices, or he can use the DVR to watch or record a virtual channel including video from one channel (from any of the source devices) and audio from another channel (from any of the source devices). When the user is watching live cable television via the DVR, and he invokes the on-screen programming guide, the DVR overlays the on-screen programming guide over the video signal from the cable set-top box, and sends the resulting video signal to the audio receiver, which sends it to the television set. If the user selects a virtual channel, the DVR controls the one or more source devices, such as by turning them on and setting them to the specified channel. The DVR then sends the virtual channel's video and (possibly unrelated) audio to the audio receiver.

### CONCLUSION

When one component is said to be adjacent another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

In particular, the invention has been described with reference to embodiments in which the virtual channel functionality is implemented within the television set itself, and in which the video circuitry, audio circuitry, and audio amplifiers are also contained within the television set itself. The invention may, of course, be practiced in a variety of other embodiments. For example, the virtual channel functionality may be provided by circuitry and/or software contained in a cable set-top box or other television receiver, or within a DVR, or within an A/V system controller, and so forth. The audio circuitry and amplifiers may be contained within an audio receiver, an A/V system controller, or the like.

The invention has been described with respect to embodiments in which the virtual channel comprises the combination of one television program's video with another television program's audio. In other embodiments, a virtual channel may comprise, for example, a television program's video and a radio program's audio, or a DVD's video and an iPod's audio, or what have you. In yet other embodiments, a virtual channel may comprise two television programs' video (e.g. in a pip setup) and an audio content from one of them or from a third source such as a satellite radio receiver.

The invention has been described with reference to methods in which the user defines the virtual channels. In other embodiments, the virtual channels can also or alternatively be defined by e.g. the cable television provider.

In some embodiments, either the video or the audio may be defined as null, such that a virtual channel comprises e.g. a football game's video and no audio, or a sitcom's audio and no video.

Virtual channels may be inserted into the on-screen programming guide so as to be adjacent the channel from which their video component is taken, adjacent the channel from which their audio component is taken, and/or grouped with other virtual channels.

In some embodiments, the virtual channel is defined at the receiver (e.g. cable set-top box) or at the DVR, and when the user opts to record the virtual channel, the DVR will record the video from the virtual channel's video source, and the audio simultaneously broadcast by the virtual channel's audio source. Then, when the user later plays the recorded virtual channel, the DVR will play the video and audio previously recorded. In other such embodiments, the user may specify that the audio or video of the virtual channel should always be “live”; in this case, when the user watches a program previously recorded from a virtual channel, the DVR will play the previously recorded video with whatever audio content is being broadcast at playback time from the audio source specified by the virtual channel (or vice versa, if the user has specified real-time video).

In some embodiments, a virtual channel may be defined as, for example, the video feed from cable channel 102 with the audio feed from satellite radio channel 37. Or, a virtual channel may be defined as the video feed from satellite television channel 408 with audio from whatever is currently being played on an iPod connected to the A/V system.

In some A/V systems, the user selects television channels by changing the channel directly on the television; that is, the television includes one or more receivers which receive television content. In other A/V systems, the user selects television channels by changing the channel on a cable set-top box or satellite television receiver; in these systems, the television set may function simply as a display panel. In still other A/V systems, the user selects television channels by changing the channel on an A/V controller unit which controls receivers located in other components such as cable set-top boxes, satellite television receivers, and so forth. Any of these may include DVR functionality. Regardless of how the A/V system is configured, the component via which the user selects television channels may be termed a “television channel selection unit”.

The user may select the virtual channel directly, by entering its channel number, rather than by selecting it from an on-screen programming guide. In this case, it may be desirable that the virtual channels have numeric rather than alphanumeric channel numbers, to facilitate their being selected via a conventional remote control unit lacking alphabetical character buttons.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method of operating an A/V system, the method comprising:
in response to a user selecting a virtual channel,
displaying, on a display panel of the A/V system, video content of a first television channel, and
playing, on at least one audio transducer of the A/V system, audio content from a source other than the first television channel.

2. The method of claim 1 wherein playing the audio content from the source other than the first television channel comprises:
playing audio content from a second television channel.

3. The method of claim 2 further comprising:
creating the virtual channel by,
(a) prompting the user to select the video content,
(b) the user selecting the video content,
(c) prompting the user to select the audio content,
(d) the user selecting the audio content, and
(e) storing information identifying the virtual channel, the information including the selected video content and the selected audio content.

4. An A/V system comprising:
a video display panel;
at least one audio transducer;
at least one video receiver coupled to receive a first video content from a video source, the video source providing the first video content with accompanying first audio content;
at least one audio receiver coupled to receive second audio content from an audio source;
channel selection means whereby, in response to the user selecting a virtual channel, the first video content is displayed on the video display panel and the second audio content is played on the at least one audio transducer.

5. The A/V system of claim 4 where:
the first video content and first audio content comprise content from a first television channel; and
the second audio content comprises audio content from a second television channel.

6. A method of operating an A/V system, the method comprising:
creating a virtual channel including video content from a first source and audio content from a second source;
in response to a user selecting the virtual channel, displaying the video content from the first source and playing the audio content from the second source.

7. The method of claim 6 wherein:
the video content comprises video from a first television channel; and
the audio content comprises audio from a second television channel.

8. The method of claim 7 further comprising:
in response to the user invoking an on-screen programming guide including an entry for the first television channel, including an entry for the virtual channel in the on-screen programming guide.

9. The method of claim 8 further comprising:
in response to the user selecting the virtual channel from the on-screen programming guide, operating an I/O switching system to (a) send the video content from the first television channel to a display panel, and (b) to send the audio content from the second television channel to an audio transducer.

10. The method of claim 6 wherein:
the video content comprises video from a first television channel; and
the audio content comprises audio from an audio source other than a television channel.

11. The method of claim 10 further comprising:
displaying an on-screen programming guide including the virtual channel; and
in response to the user selecting the virtual channel from the on-screen programming guide, operating an I/O switching system to (a) send the video content from the first television channel to a display panel, and (b) to send the audio content from the audio source to an audio transducer.

12. A television channel selection unit comprising:
at least one input for receiving a plurality of television channels;
at least one output for sending a video output signal;
at least one output for sending an audio output signal;
an on-screen menu system for including an on-screen programming guide in the video output signal;
a channel selection system via which a user can select among the television channels;
means for enabling the user to create a virtual channel including video from one of the television channels and audio from a source other than the one of the television channels; and
an I/O control system adapted to, in response to the user selecting the virtual channel, (a) include the video from the one of the television channels in the video output signal, and (b) include the audio from the source in the audio output signal.

13. The television channel selection unit of claim 12 wherein:
the source comprises another of the television channels.

14. The television channel selection unit of claim 12 further comprising:
a display panel.

15. The television channel selection unit of claim 12 comprising:
a DVR.
